(19) United States
(12) Patent Application Publication
(10) Pub. No.: US 2023/0413320 A1
(43) Pub. Date: Dec. 21, 2023

(54) ON UE'S TRANSMISSION CONFIGURED WITH MULTIPLE CHANNEL OCCUPANCY TIME ACCESS

(71) Applicant: Telefonaktiebolaget LM Ericsson (publ), STOCKHOLM (SE)

(72) Inventors: Bikramjit Singh, RAASEPORI (FI); Sorour Falahati, STOCKHOLM (SE); Yufei Blankenship, KILDEER, IL (US)

(21) Appl. No.: 18/032,553

(22) PCT Filed: Oct. 18, 2021
(86) PCT No.: PCT/IB2021/059586

§ 371 Date: Apr. 18, 2023

Related U.S. Application Data
(60) Provisional application No. 63/093,251, filed on Oct. 18, 2020.

(51) Int. Cl. H04W 74/08

(52) U.S. Cl. CPC H04W 74/0808; H04W 74/0875

(57) ABSTRACT

Systems and methods are disclosed that relate to transmission by a radio node having an opportunity to use any of multiple Channel Occupancy Times (COTs). In one embodiment, a method performed by a radio node comprises determining, for a particular transmission, that the radio node has an opportunity to use either of two COTs consisting of a base station initiated COT and a wireless device initiated COT. The method further comprises, responsive to determining that the radio node has an opportunity to use either of the two COTs, selecting) a particular COT from among the two COTs to be used for the particular transmission. The method further comprises determining that an idle period associated to the particular COT is a valid idle period in which no transmissions to or from the radio node are to occur.

### RELATED APPLICATIONS

This application claims the benefit of provisional patent application Ser. No. 63/093,251, filed Oct. 18, 2020, the disclosure of which is hereby incorporated herein by reference in its entirety.

### TECHNICAL FIELD

The present disclosure relates to Channel Occupancy Time (COT) sharing in a cellular communications system.

### BACKGROUND

Ultra-Reliable and Low Latency Communication (URLLC) is one of the main use cases of Third Generation Partnership Project (3GPP) Fifth Generation (5G) New Radio (NR). URLLC has strict requirements on transmission reliability and latency, i.e., 99.9999% reliability within 1 millisecond (ms) one-way latency. In NR Release 15, several new features and enhancements were introduced to support these requirements. In Release 16, standardization works are focused on further enhancing URLLC system performance as well as ensuring reliable and efficient coexistence of URLLC and other NR use cases. One example scenario is when both enhanced Mobile Broadband (eMBB) and URLLC User Equipments (UEs) co-exist in the same cell. Here, mainly two approaches have been identified to support multiplexing/prioritization.

In addition to operation in licensed bands, NR has been enhanced in 3GPP Release 16 (RP-190706, Revised WID on NR-based Access to Unlicensed Spectrum) to allow operation in unlicensed bands, i.e., NR-Unlicensed (NR-U). Allowing unlicensed networks, i.e., networks that operate in unlicensed or shared spectrum to effectively use the available spectrum is an attractive approach to increase system capacity. For convenience, the term “unlicensed spectrum” is used to refer to both unlicensed and shared spectrum.

Although it is more challenging to match the qualities of the licensed regime on unlicensed spectrum, solutions that allow an efficient use of it as a complement to licensed deployments have the potential to bring great value to the 3GPP operators, and, ultimately, to the 3GPP industry as a whole. Some features in NR need to be adapted to comply with the special characteristics of the unlicensed band as well as also different regulations. Further, if a UE intends to use unlicensed spectrum, it may employ Clear Channel Assessment (CCA) schemes to find out whether the channel is free or not over a certain period. One such technique is Listen Before Talk (LBT). There are many different flavors of LBT, depending on which channel access mode the device uses and which type of data it wants to transmit in the upcoming transmission opportunity, referred to as channel occupancy time (COT). Common for all flavors is that the sensing is done in a particular channel (corresponding to a defined carrier frequency) and over a predefined bandwidth. Further, two modes of access operations are defined—Frame-Based Equipment (FBE) and Load-Based Equipment (LBE). In FBE mode, the sensing period is simple, while the sensing scheme in LBE mode is more complex.

In FBE mode as defined in 3GPP Release 16 and illustrated in FIG. 1, there is semi-static channel occupancy. More specifically, the NR base station (gNB) assigns Fixed Frame Periods (FFPs), senses the channel for 9 microseconds (μs) just before the FFP boundary, and, if the channel is sensed to be free, it starts with a downlink (DL) transmission. With the DL transmission at the beginning of an FFP, the gNB has initiated a COT during that FFP. The gNB can share this COT with UEs for uplink (uplink) transmissions configured or scheduled for the UEs or other DL transmissions. If the gap between consecutive transmissions are more than 16 μs, a 9 μs successful sensing is required before a transmission in the COT.

In each FFP, DL/UL transmissions are only allowed within a subset of FFP time resource, where the remaining time at the end of the FFP is reserved so that other nodes also have the chance to sense and utilize the channel. The reserved time at the end of each FFP is referred to as an IDLE period.

This procedure can be repeated with a certain periodicity. Hence in FBE operation, the channel is sensed at specific intervals just before the FFP boundary. The FFP can be set to values between 1 and 10 milliseconds (ms) and can be changed after a minimum of 200 ms. The IDLE period is a regulatory requirement and is supposed to be at least T_{IDLE}≥max(0.05*COT, 100 μμs). In 3GPP Technical Specification (TS) 37.213, this has been simplified to be T IDLE >max(0.05*FFP, 100 μs), i.e. the maximum channel occupancy time (MCOT) would be defined as T_{MCOT}=min(0.95*FFP, FFP−0.1 ms). So for 10 ms FFP, the MCOT would be 9.5 ms, while for 1 ms FFP the MCOT would be 0.9 ms=0.9*FFP.

The FBE mode supported in Release 16 is referred to as “gNB-initiated COT” where a DL transmission at the beginning of an FFP determines that that FFP before the corresponding idle period can be used by gNB and UE for DL and UL transmissions, respectively. In this manner, gNB is “initiating” the COT, and UEs are “sharing” the COT that is initiated by gNB.

In Release 17, 3GPP supports “UE-initiated COT” in addition to gNB-initiated COT. The details of the procedure are under discussion while the same principle as gNB initiated COT is applicable. That implies that a UE would be associated with an FFB that might be the same or different from the gNB FFP. If the UE transmits a UL transmission at the beginning of FFP after successfully sensing the channel for 9 μs, the UE has initiated a COT in that FFP that can be shared with gNB.

The default LBT mechanism for LBE operation, LBT category 4, provides dynamic channel occupancy. More specifically, LBT category 4 is similar to existing Wi-Fi operation, where a node can sense the channel at any time and start transmitting if the channel is free after a deferral and backoff period. For specific cases, e.g. shared COT, other LBT categories allowing a very short sensing period are allowed.

In regard to LBT channels in wideband operation mode, there are different wideband operation modes. The nodes perform LBT on a certain bandwidth referred to as an “LBT channel”, which are up to 20 Megahertz (MHz). The transmission bandwidth is therefore also limited by the LBT bandwidth. The channels can however be aggregated in wideband operation modes using either carrier aggregation or using one wideband carrier which is divided into several so-called resource block sets, RB sets. An RB set is also referred to as an LBT bandwidth or LBT subband. In either mode, the LBT can be performed according to one of the following procedures: (1) independent category 4 (CAT4) LBT on each of the carriers, (2) CAT4 LBT on the primary carrier and sensing for a fixed CCA on the remaining carriers just before the end of the CAT4 LBT on the primary carrier.

Same as in NR, a UE in NR-U can be semi-statically scheduled for uplink transmission based on Type 1 or Type 2 configured grant (CG). There have been specific enhancements in configured grant related to time-domain resource allocation, configured grant Uplink Control Information (CG-UCI), and autonomous uplink (AUL) transmission.

In NR-U, a new timer is introduced named as CG re-transmission timer (CGRT). This timer can be used for AUL. There is also another timer configuredGrantTimer (CGT). CGT limits maximum AUL retransmission attempts for a Hybrid Automatic Repeat Request (HARQ) process. When the CGT expires, the UE should flush the HARQ buffer for this HARQ process and transmit new data associated to it. An example is illustrated in FIG. 2.

As stated 3GPP TS 38.321 V16.0.0, Section 5.8.2, there are three types of transmission without dynamic grant:
configured grant Type 1 where an uplink grant is provided by RRC, and stored as configured uplink grant;
configured grant Type 2 where an uplink grant is provided by PDCCH, and stored or cleared as configured uplink grant based on L1 signalling indicating configured uplink grant activation or deactivation;
retransmissions on a stored configured uplink grant of Type 1 or Type 2 configured with cg-RetransmissionTimer.

### In TS 38.321 V16.0.0:

For configured uplink grants neither configured with harq-ProcID-Offset2 nor with cg-RetransmissionTimer, the HARQ Process ID associated with the first symbol of a UL transmission is derived from the following equation:

HARQ Process ID=[floor(CURRENT_symbol/periodicity)]modulo nrofHARQ-Processes
For configured uplink grants with harq-ProcID-Offset2, the HARQ Process ID associated with the first symbol of a UL transmission is derived from the following equation:

HARQ Process ID=[floor(CURRENT_symbol/periodicity)]modulo nrofHARQ-Processes+harq-ProcID-Offset2
where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211 [8].
For configured uplink grants configured with cg-RetransmissionTimer, the UE implementation select an HARQ Process ID among the HARQ process IDs available for the configured grant configuration. The UE shall prioritize retransmissions before initial transmissions. The UE shall toggle the NDI in the CG-UCI for new transmissions and not toggle the NDI in the CG-UCI in retransmissions.

### In Section 5.4.2.1 in TS 38.321 V16.0.0:

For configured uplink grants configured with cg-RetransmissionTimer, the redundancy version zero is used for initial transmissions and UE implementation selects redundancy version for retransmissions.

CG-UCI is included in every CG Physical Uplink Shared Channel (CG-PUSCH) transmission and includes the information listed in Table 1. CG-UCI is mapped as per Release 15 rules with CG-UCI having the highest priority. It is mapped on the symbols starting after first Demodulation Reference Signal (DMRS) symbol. To determine the number of Resource Elements (REs) used for CG-UCI, the mechanism of beta-offset in Release 15 NR for HARQ Acknowledgment (HARQ-ACK) on CG-PUSCH is reused. Nonetheless, a new Radio Resource Control (RRC) configured beta-offset for CG-UCI is defined.

TABLE 1
CG-UCI content

UCI content
HARQ
RV
NDI
COT sharing information
CRC

If CG-PUSCH resources overlap with Physical Uplink Control Channel (PUCCH) carrying Channel State Information (CSI)-part 1 and/or CSI-part 2, the later can be sent on CG-PUSCH. RRC configuration can be provided to the UE indicating whether to multiplex CG-UCI and HARQ-ACK. If configured, in the case of PUCCH overlapping with CG-PUSCH(s) within a PUCCH group, the CG-UCI and HARQ-ACK are jointly encoded as one UCI type. Otherwise, configured grant PUSCH is skipped if CG-PUSCH overlaps with PUCCH that carries HARQ ACK feedback.

To reduce the signaling overhead corresponding to explicit feedback transmission, NR-U supports an enhanced Downlink Control Information (DCI) format 0_1 for indicating downlink feedback information (“CG-DFI”) that carries a HARQ-ACK bitmap for all UL HARQ processes from the same UE. Additionally, the gNB may trigger an adaptive retransmission using a dynamic grant.

In Section 6.1 in specification 38.214 V 16.1.0, it is stated that
“If a UE receives an ACK for a given HARQ process in CG-DFI in a PDCCH ending in symbol i to terminate a transport block repetition in a PUSCH transmission on a given serving cell with the same HARQ process after symbol i, the UE is expected to terminate the repetition of the transport block in a PUSCH transmission starting from a symbol j if the gap between the end of PDCCH of symbol i and the start of the PUSCH transmission in symbol j is equal to or more than N2 symbols. The value N2 in symbols is determined according to the UE processing capability defined in Clause 6.4, and N2 and the symbol duration are based on the minimum of the subcarrier spacing corresponding to the PUSCH and the subcarrier spacing of the PDCCH indicating CG-DFI.”

In regard to DL preemption in NR, once DL URLLC data appears in a buffer, a base station should choose the earliest moment of time when resources can be normally allocated without colliding with the resources allocated for an already ongoing downlink transmission for the corresponding UE. This may be either in the beginning of the slot or a mini-slot where the mini-slot can start at any Orthogonal Frequency Division Multiplexing (OFDM) symbol. Hence, downlink pre-emption may happen when long term allocation(s) (e.g., slot based) occupy resources (particularly wideband resources) and there is no room for URLLC data transmission, typically supported using a mini-slot. In this case, a scheduler can send DCI to the UE for which the URLLC data is intended and thereby inform the UE that an override (pre-emption) has been triggered for the ongoing transmission in downlink When an eMBB DL transmission is pre-empted, the pre-empted part of the original message pollutes the soft buffer (only noise/interference is received). It is therefore important (though not required by the standard) to flush the affected bits from the soft buffer to increase the decodability of the eMBB data at the UE. If not, the pre-empted bits may negatively impact decoding in retransmissions, which will likely happen. Release 15 allows DCI based indication of the DL pre-emption by explicit signaling, which is carried either:
(Option 1) by special DCI format 2_1 over group common PDCCH (TS38.213, section 7.3.1.3.2 and clarified, Section 11.2 “Discontinuous transmission indication”), or
(Option 2) by special flag in multi-CBG retransmission DCI “CBG flushing out information” (TS38.213, section 7.3.1.2—DCI formats for scheduling of PDSCH).

Option 1 gives an indication as a 14-bit bitmap, which addresses reference downlink resource domains in between two pre-emption indication (PI) messages. The reference resource is configured by RRC, where the highest resolution of this signaling in time is 1 OFDM symbol and in frequency is half of the BWP (Bandwidth Part), but not at the same time. The longer the periodicity of messages, the coarser the resolution. The group common DCI format 2_1 indicates which part of the configured reference resource is preempted. Since this is a group common signaling, all UEs within the BWP may read it.

Option 2 is a user specific way of signaling. The HARQ retransmission DCI, which contains a set of CB/CBGs, may have a special bit to indicate that the UE must overwrite existing bits in the soft buffer (do not combine) by retransmitted CB/CBGs soft bits. In this case, the gNB is responsible for determination of a subset of CB/CBGs which needs to be flushed before the soft-combining process. This option is not considered further in the present disclosure.

In Release 16, two methods are adopted to enable inter-UE UL cancellation (aka, pre-emption) in NR.

The first method is based on power control to increase the power of the URLLC to make it more resilient to interference from the eMBB user(s). Additional power control for Release 16 UEs are specified in 3GPP TS 38.213, Section 7.1.1. The main advantage with this option is that it does not require any changes in the behavior of the eMBB UE; hence it works with Release 15 UEs. One disadvantage is that to guarantee the performance of the URLLC UE while being interfered by eMBB traffic, the transmit power spectral density (PSD) may have to be increased significantly which can cause interference to other cells. Also, UEs not in the close vicinity of the gNB may not have the power budget to do this increase and will therefore experience much lower Signal to Interference and Noise Ratio (SINR) than the required.

The second method is based on a cancellation indicator being transmitted from the gNB to the interfering eMBB UEs. When a URLLC UE is scheduled on time/frequency resources that are already scheduled to a lower priority eMBB UE, the gNB can transmit a cancellation indicator to the eMBB UE. Upon reception of this indicator, the eMBB UE will avoid transmitting on a set of indicated resources. The details of the cancellation indicator and the UE behavior upon reception of this signal is specified in 3GPP TS 38.213.

The mechanism for UL cancellation indication (CI) includes a reference time-frequency region that is configured for the UE by RRC signaling, and a DCI that indicates parts of the configured resources within which the transmission should be cancelled. The reference time-frequency region is also referred to as “reference resource”, RR. The size of the cancellation indication DCI as well as the time domain granularity are configurable. The frequency domain granularity can then be determined from the total bit field size and the time domain granularity.

A typical use case for this is when eMBB traffic is scheduled in a whole slot and all Physical Resource Blocks (PRBs) and time sensitive URLLC needs to be transmitted. Here, time sensitive means that it requires instant access to the channel and waiting until the next slot before transmission will introduce too much delay. In NR, URLLC traffic may be scheduled on one or a few OFDM symbols and with a significantly shorter time from the uplink grant to when the uplink transmission takes place. This means that eMBB users may already have been scheduled on all available time/frequency resources. With the cancellation indicator the gNB can choose to cancel the eMBB traffic and hence reduce the interference to the URLLC UE.

### SUMMARY

Systems and methods are disclosed that relate to transmission by a radio node having an opportunity to use any of multiple Channel Occupancy Times (COTs). In one embodiment, a method performed by a radio node comprises determining, for a particular transmission, that the radio node has an opportunity to use either of two COTs consisting of a base station initiated COT and a wireless device initiated COT. The method further comprises, responsive to determining that the radio node has an opportunity to use either of the two COTs, selecting) a particular COT from among the two COTs to be used for the particular transmission. The method further comprises determining that an idle period associated to the particular COT is a valid idle period in which no transmissions to or from the radio node are to occur. In this manner, non-deterministic behavior when the radio node has the opportunity to transmit on multiple COTs is avoided.

In one embodiment, selecting the particular COT from among the two COTs comprises selecting the particular COT from among the two COTs based on one or more predefined rules. In one embodiment, the one or more predefined rules comprise a rule that is based on priority of the two COTs relative to one another.

In one embodiment, the radio node is a wireless communication device, and the method further comprises receiving information from a base station that indicates the priority of the base station initiated COT relative to that of the wireless device initiated COT. In one embodiment, receiving the information comprises receiving the information via: downlink control information (DCI), downlink (DL) semi-persistent scheduling (SPS) activation or release DCI, radio resource control (RRC) configuration, a new DCI signaling to indicate changes in COT priority, physical downlink shared channel (PDSCH), or system information block (SIB) signaling. In one embodiment, the rule that is based on the priority of the two COTs relative to one other is a rule that a highest priority COT of the two COTs is to be considered by the radio node first when the radio node has an opportunity to use either of the two COTs. In one embodiment, the rule is further that a lowest priority COT of the two COTs is to be considered by the radio node only if the idle period associated to the highest priority COT occurs during the particular transmission.

In one embodiment, the radio node is a wireless communication device, the particular transmission is an uplink transmission, and the one or more rules comprise a rule that if the uplink transmission starts at a beginning of an Fixed Frame Period (FFP) associated to the wireless communication device and ends before an idle period associated to the FFP, the wireless device initiated COT is to be selected or considered first for the particular transmission.

In one embodiment, the radio node is a wireless communication device, the particular transmission is an uplink transmission, and the one or more rules comprise a rule that if the uplink transmission starts at a beginning of a FFP associated to a base station associated to the base station initiated COT and ends before an idle period associated to the FFP and the wireless communication device has already determined that the base station initiated COT is initiated, the base station initiated COT is to be selected or considered first for the particular transmission.

In one embodiment, the radio node is a wireless communication device, the particular transmission is a downlink transmission, and the one or more rules comprise a rule that if the downlink transmission starts within a FFP associated to a base station associated to the base station initiated COT and ends before an idle period associated to the FFP, the base station initiated COT is to be selected or considered first for the particular transmission.

In one embodiment, the radio node is a wireless communication device, the particular transmission is a second uplink transmission that is subsequent to a first uplink transmission associated to the wireless device initiated COT in a Fixed FFP, and the one or more rules comprise a rule that the second uplink transmission is also associated to the wireless device initiated COT if the second uplink transmission ends before an idle period of the FFP.

In one embodiment, the radio node is a wireless communication device, the particular transmission is a second uplink transmission that is subsequent to a first uplink transmission associated to the base station initiated COT in a FFP, and the one or more rules comprise a rule that the second uplink transmission is also associated to the base station initiated COT if the second uplink transmission ends before an idle period of the FFP.

In one embodiment, the radio node is a wireless communication device, the particular transmission is an uplink transmission, and selecting the particular COT from among the two COTs comprises selecting the particular COT from among the two COTs autonomously. In one embodiment, the method further comprises sending, to a base station associated to the base station initiated COT, information that indicates a priority of the two COTs relative to one another.

In one embodiment, the radio node is a wireless communication device, and the method further comprises choosing the priority of the two COTs relative to one another. In one embodiment, choosing the priority of the two COTs relative to one another comprises choosing the priority of the two COTs relative to one another based on a rule. In one embodiment, choosing the priority of the two COTs relative to one another comprises choosing the priority of the two COTs relative to one another based on durations of respective idle periods for the two COTs.

In one embodiment, the radio node is a wireless communication device, and the wireless communication device is configured with two or more FFPs. In one embodiment, idle periods from one or more FFPs of a base station and idle periods of the two or more FFPs of the wireless communication device are excluded from a downlink preemption resource and/or an uplink cancellation reference resource. In one embodiment, idle periods from the two or more FFPs of the wireless communication device are included in a downlink preemption resource and/or an uplink cancellation reference resource. In one embodiment, idle periods from one or more FFPs of a base station, but not idle periods of the two or more FFPs of the wireless communication device, are excluded from a downlink preemption resource and/or an uplink cancellation reference resource.

In one embodiment, the radio node is a wireless communication device, the particular transmission is an uplink transmission, and selecting the particular COT comprises selecting the particular COT from among the two COTs to be used for the uplink transmission based on an uplink transmission type of the UL transmission.

In one embodiment, the radio node is a wireless communication device, the particular transmission is an uplink transmission, and selecting the particular COT comprises selecting the particular COT from among the two COTs to be used for the uplink transmission based on one or more time-domain characteristics of the uplink transmission.

In one embodiment, the radio node is a wireless communication device, the particular transmission is an uplink transmission, and selecting the particular COT comprises selecting the particular COT from among the two COTs to be used for the uplink transmission based on an importance of the uplink transmission.

In one embodiment, the method further comprises transmitting or receiving the particular transmission in the particular COT.

In one embodiment, the radio node is a wireless communication device.

In one embodiment, the radio node is a base station.

Corresponding embodiments of a wireless communication device are also disclosed. In one embodiment, a wireless communication device comprises one or more transmitters, one or more receivers, and processing circuitry associated with the one or more transmitters and the one or more receivers. The processing circuitry is configured to cause the wireless communication device to determine, for a particular transmission, that the radio node has an opportunity to use either of two COTs consisting of a base station initiated COT and a wireless device initiated COT. The processing circuitry is further configured to cause the wireless communication device to, responsive to determining that the radio node has an opportunity to use either of the two COTs, select a particular COT from among the two COTs to be used for the particular transmission. The processing circuitry is further configured to cause the wireless communication device to determine that an idle period associated to the particular COT is a valid idle period in which no transmissions to or from the radio node are to occur.

Corresponding embodiments of a base station are also disclosed. In one embodiment, a base station comprises processing circuitry configured to cause the base station to determine, for a particular transmission, that the radio node has an opportunity to use either of two COTs consisting of a base station initiated COT and a wireless device initiated COT. The processing circuitry is further configured to cause the base station to, responsive to determining that the radio node has an opportunity to use either of the two COTs, select a particular COT from among the two COTs to be used for the particular transmission. The processing circuitry is further configured to cause the base station to determine that an idle period associated to the particular COT is a valid idle period in which no transmissions to or from the radio node are to occur.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Frame-Based Equipment (FBE) mode defined in 3^{rd} Generation Partnership Project (3GPP) Release 16;

FIG. 2 illustrates an example of the Configured Grant (CG) re-transmission timer (CGRT) and the Configured Grant Timer (CGT) defined in 3GPP New Radio in Unlicensed spectrum (NR-U) specifications;

FIG. 3 illustrates an example with multiple candidates for valid idle periods when there are overlapping Fixed Frame Periods (FFPs) and a downlink (DL) or uplink (UL) transmission can occur in a NR base station (gNB) initiated Channel Occupancy Time (COT) or a User Equipment (UE) initiated COT, or both;

FIG. 4 illustrates one example of a cellular communications system in which embodiments of the present disclosure may be implemented;

FIG. 5 is a flow chart that illustrates the operation of a radio node in accordance with at least some embodiments of the present disclosure;

FIGS. 6, 7, and 8 are schematic block diagrams of example embodiments of a radio access node, or base station;

FIGS. 9 and 10 are schematic block diagrams of example embodiments of a wireless communication device or UE;

FIG. 11 illustrates a communication system in which embodiments of the present disclosure may be implemented;

FIG. 12 illustrates example implementations of the UE, base station, and host computer of FIG. 11;

FIGS. 13, 14, 15, and 16 illustrate example methods implemented in a communication system such as that of FIG. 11 in accordance with some embodiments of the present disclosure;

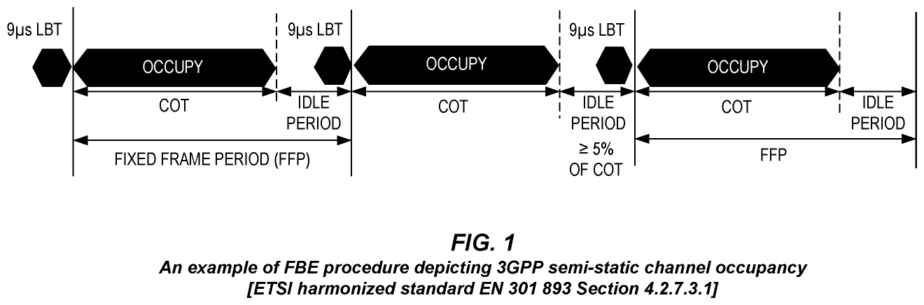

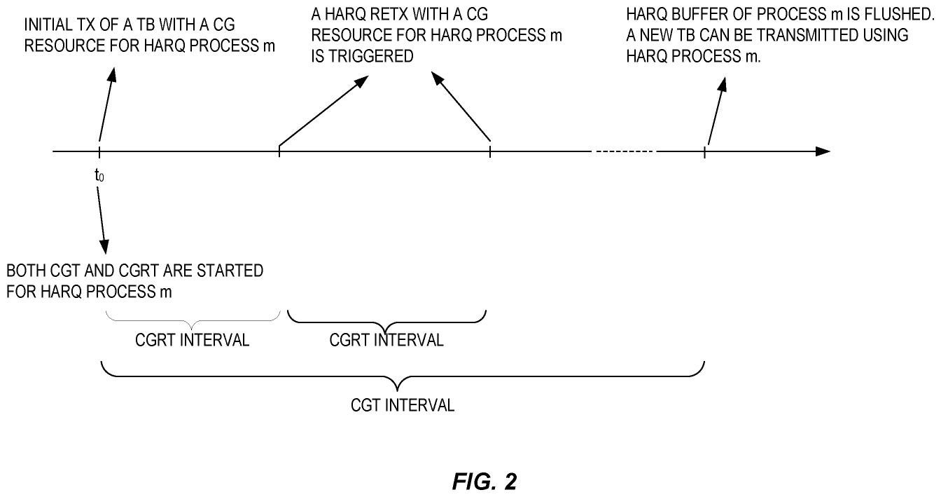

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.
Radio Node: As used herein, a “radio node” is either a radio access node or a wireless communication device.
Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.
Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.
Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.
Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.
Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In 3GPP Release 16, a UE transmits in a gNB initiated Channel Occupancy Time (COT). 3GPP has agreed to add another possibility with UE-initiated COT in Release 17. When these COTs are available, the UE and the gNB each has the possibility to transmit in either COT, either by initiating a COT or sharing an initiated COT. Each COT is associated to a Fixed Frame Period (FFP) including an idle period. Based on the following 3GPP agreement, if a UE or gNB initiates or shares a COT for a transmission, the UE or gNB is not allowed to transmit in the idle period of the FFP associated to that COT.

### Agreements:

For semi-static channel access mode,
   When gNB operates as an initiating device
      The gNB is not allowed to transmit during the idle period of any FFP associated with the gNB in which the gNB initiates a COT
   When a UE operates as an initiating device
      The UE is not allowed to transmit during the idle period of any FFP associated with the UE in which the UE initiates a COT
   When a UE shares a COT initiated by the gNB during an FFP associated with the gNB
      The UE is not allowed to transmit during the idle period of that FFP in which the UE shares the COT initiated by the gNB
   When the gNB shares a COT initiated by a UE during an FFP associated with the UE
      The gNB is not allowed to transmit during the idle period of that the FFP in which the gNB shares the COT initiated by the UE
   FFS whether/how to support additional restrictions to the idle period

When there are overlapping FFPs, a downlink (DL) or uplink (UL) transmission can occur in a gNB initiated COT or a UE initiated COT or both. In case the DL or UL transmission occurs in either a gNB initiated COT or a UE initiated COT, there would be a valid idle period following up the transmission based on the agreement above where the idle period would not include any DL or UL transmission, respectively. In case the DL or UL transmission occurs in both gNB initiated COT and UE initiated COT, there would be two idle periods following up the transmission based on the agreement above, while only one of the idle periods should be considered the valid idle period where the valid idle period would not include any DL or UL transmission, respectively.

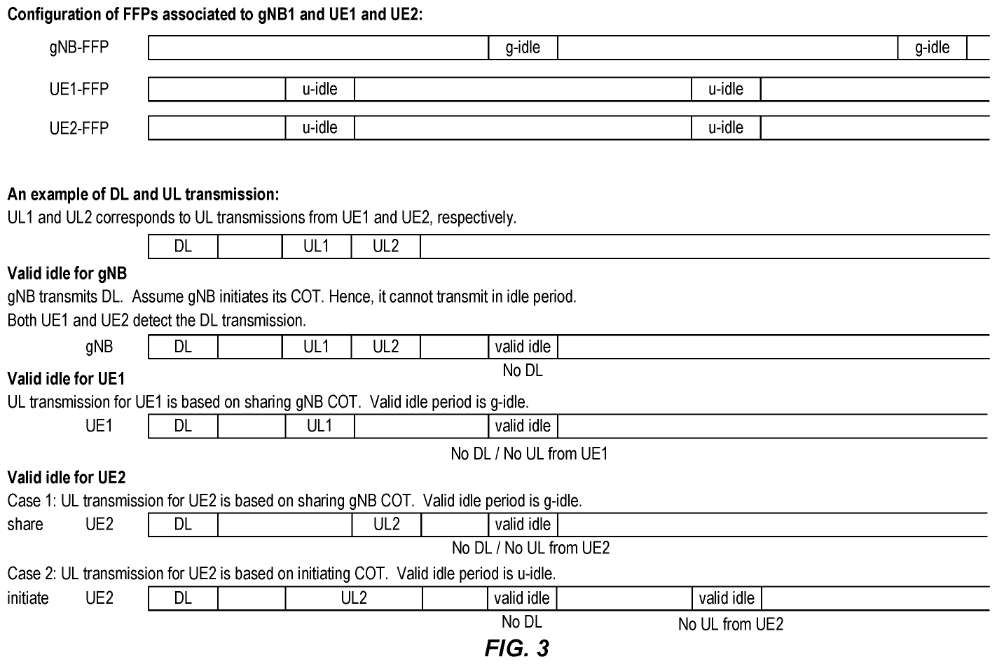

Therefore, multiple candidates for a valid idle period can lead to non-deterministic behavior unless a rule is devised for a transmission in a COT when a UE has the possibility to transmit in multiple COTs. FIG. 3 illustrates an example with multiple candidates for valid idle periods.

Another problem is ambiguity in puncturing/cancellation/preemption when a UE has multiple COTs at its disposal. The UE can be configured with UL cancellation and DL preemption reference regions for the puncturing/cancellation/preemption where a previously scheduled lower-priority transmission of a UE is preempted/cancelled/punctured by some other higher-priority transmission of different UE. Therefore, to support preemption, the reference region must exclude the invalid symbols, e.g., for UL reference region, it must exclude DL symbols or some reference signaling resources, and vice-versa for DL reference region [Section 11.2, 11.2A, 3GPP TS 38.213, see below, the quoted text]. Furthermore, if a UE has only one FFP/COT available, then the idle period is excluded from the reference region (for both UL and DL preemption). However, when multiple FFPs/COTs are available, then some idle periods cannot be deemed invalid, and thus require new treatment for the idle periods which are valid in defining reference region for UL/DL preemption.
Section 11.2, 38.213
. . .
If the UE is provided tdd-UL-DL-ConfigurationCommon, symbols indicated as uplink by tdd-UL-DL-ConfigurationCommon are excluded from the last N_{symb}^{sloy}·T_{INT}·2^{μ-μ}^{_{INT}} symbols prior to the first symbol of the CORESET in the slot. The resulting set of symbols includes a number of symbols that is denoted as N_{INT}.
. . .
Section 11.2A, 38.213
. . .
T_{CI} a number of symbols, excluding symbols for reception of SS/PBCH blocks and DL symbols indicated by tdd-UL-DL-ConfigurationCommon, from a number of symbols that
. . .

Certain aspects of the present disclosure and their embodiments may provide solutions to the aforementioned or other challenges. For a UL or DL transmission, a UE or gNB may respectively have the opportunity to transmit in either of a gNB-initiated COT and a UE-initiated COT. In the description below, rules are provided based on which the UE or gNB selects a COT for its UL or DL transmission, respectively. When a UE-initiated COT or a gNB initiated COT is selected, the idle period ending the FFP associated to that COT is considered as the valid idle period.

Certain embodiments may provide one or more of the following technical advantage(s). When multiple COTs are available to a node, the transmission in COT based on some rule helps to eliminate non-deterministic behavior.

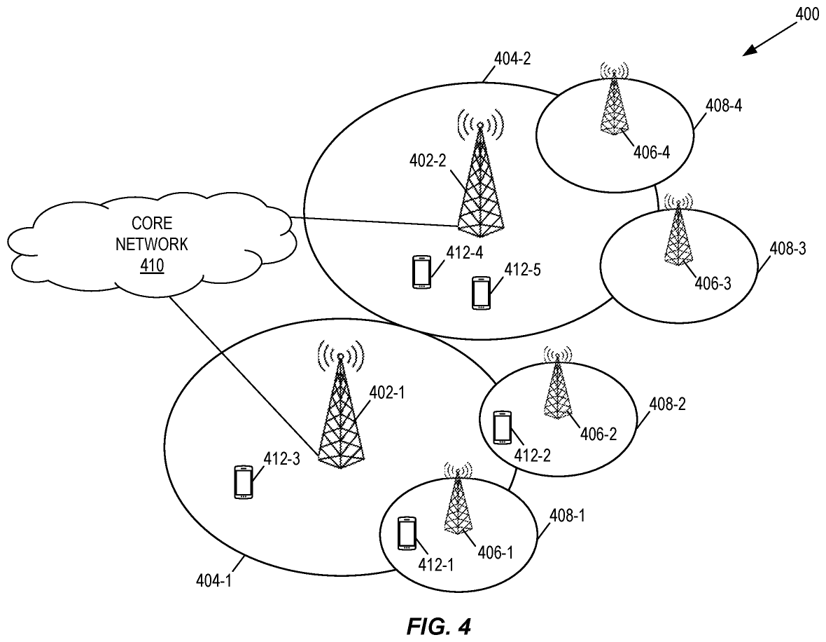

FIG. 4 illustrates one example of a cellular communications system 400 in which embodiments of the present disclosure may be implemented. In the embodiments described herein, the cellular communications system 400 is a 5G system (5GS) including a Next Generation RAN (NG-RAN) and a 5G Core (5GC); however, the solutions described herein are not limited thereto. In this example, the RAN includes base stations 402-1 and 402-2, which in the 5GS include NR base stations (gNBs) and optionally next generation eNBs (ng-eNBs) (e.g., LTE RAN nodes connected to the 5GC), controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low power nodes 406-1 through 406-4 controlling corresponding small cells 408-1 through 408-4. The low power nodes 406-1 through 406-4 can be small base stations (such as pico or femto base stations) or Remote Radio Heads (RRHs), or the like. Notably, while not illustrated, one or more of the small cells 408-1 through 408-4 may alternatively be provided by the base stations 402. The low power nodes 406-1 through 406-4 are generally referred to herein collectively as low power nodes 406 and individually as low power node 406. Likewise, the small cells 408-1 through 408-4 are generally referred to herein collectively as small cells 408 and individually as small cell 408. The cellular communications system 400 also includes a core network 410, which in the 5G System (5GS) is referred to as the 5GC. The base stations 402 (and optionally the low power nodes 406) are connected to the core network 410.

The base stations 402 and the low power nodes 406 provide service to wireless communication devices 412-1 through 412-5 in the corresponding cells 404 and 408. The wireless communication devices 412-1 through 412-5 are generally referred to herein collectively as wireless communication devices 412 and individually as wireless communication device 412. In the following description, the wireless communication devices 412 are oftentimes UEs, but the present disclosure is not limited thereto.

Now, a description of embodiments of the present disclosure will be provided. For this description, the base stations 402 are gNBs and, as such, are sometimes referred to as gNBs 402. Similarly, the wireless communication devices 412 are UEs and, as such, are sometimes referred to as UEs 412.

For a UL or DL transmission, a UE 412 or gNB 402 may respectively have the opportunity to transmit in either of a gNB-initiated COT and a UE-initiated COT. In the description below, rules are provided based on which the UE 412 or gNB 402 selects a COT for its UL or DL transmission, respectively. When a UE-initiated COT or a gNB-initiated COT is selected, the idle period ending the FFP associated to that COT is considered as the valid idle period.

In one option, if the UE 412 has the opportunity to transmit in both a gNB-initiated COT and a UE-initiated COT, the UE 412 always considers first to transmit in the UE-initiated COT. If the UE-initiated COT has an idle period during its intended UL transmission, the UE 412 then considers the gNB-initiated COT in case the COT period is valid (i.e., no idle period in gNB-initiated COT). In other words, the UE-initiated COT is always prioritized over the gNB-initiated COT for UL transmission, unless the intended UL transmission is not possible in the UE-initiated COT.

In one option, if the UE 412 has the opportunity to transmit in both a gNB-initiated COT and a UE-initiated COT, the UE 412 always considers first to transmit in the gNB-initiated COT. If the gNB-initiated COT has an idle period during its intended UL transmission, the UE 412 then considers the UE-initiated COT in case the COT period is valid (i.e., no idle period in UE-initiated COT). In other words, the gNB-initiated COT is always prioritized over the UE-initiated COT for UL transmission, unless the intended UL transmission is not possible in the gNB-initiated COT.

In one option, the gNB 402 communicates the priority of the COT (between gNB-initiated COT and UE-initiated COT) for an UL transmission or DL transmission in case the UE 412 has the opportunity to transmit in both a gNB-initiated COT and a UE-initiated COT. The gNB 412 can communicate this priority using any of following non-limiting options:
Downlink Control Information (DCI), e.g., DCI scheduling of an UL transmission or a DL transmission
Configured Grant (CG) or DL Semi-Persistent Scheduling (SPS) activation or release DCI
Radio Resource Control (RRC) configuration, e.g., RRC activation of a CG or RRC configuration of Physical Uplink Shared Channel (PUSCH)
A new DCI signaling to indicate changes in COT priority
Physical Downlink Shared Channel (PDSCH), e.g., a DL transmission multiplexed with control information indicating to COT priority
System Information Block (SIB) signaling
   Note: The priority here refers to the prioritization between gNB-initiated COT and UE-initiated COT. For example, if the UE 412 has to opportunity to transmit in both a gNB-initiated COT and a UE-initiated CO at some time instant and if the stated priority for the gNB-initiated COT is set higher with respect to the UE-initiated COT, then the UE 412 must first consider transmission in the gNB-initiated COT.

For example, if the gNB 402 communicates to the UE 412 an indication that a UE-initiated COT is prioritized in a DCI, then the UE 412 always considers first to transmit in a UE-initiated COT. If the idle period corresponding to the UE-initiated COT occurs during the intended UL transmission, the UE 412 then considers the gNB-initiated COT in case the UL transmission during the COT is valid and not occurring during the corresponding idle period in the gNB-initiated COT. In other words, the UE-initiated COT is always prioritized over gNB-initiated COT for UL transmission.

In one option, the gNB 412 indicates by DCI for a scheduled UL transmission or a DL transmission whether gNB-initiated COT or UE-initiated COT is applicable.

In one option, if a UL transmission with or without scheduling DCI starts at the beginning of an FFP associated to the UE 412 and ends before the idle period corresponding to that FFP, the UE 412 assumes UE-initiated COT for the UL transmission and does not transmit any UL transmission in the corresponding idle period. In another example, if a UL transmission with or without scheduling DCI starts within an FFP associated to the gNB 402 and ends before the idle period corresponding to that FFP and the UE 412 has already determined that the gNB initiated COT is initiated, the UE 412 assume gNB-initiated COT for the UL transmission and does not transmit any UL transmission or expect to receive any DL transmission in the corresponding idle period.

In one option, if a DL transmission with or without scheduling DCI starts within an FFP associated to the gNB 412 and ends before the idle period corresponding to that FFP, the UE 412 assumes gNB-initiated COT for the DL transmission and is not expecting any DL transmission in the corresponding idle period.

In one option, if a first UL transmission is associated to the UE initiated COT in an FFP, a second UL transmission ending before the idle period of that FFP is also associated to the UE initiated COT, and the UE 412 does not transmit any UL in the corresponding idle period. In another example, if a first UL transmission is associated to the gNB initiated COT in an FFP, a second UL transmission ending before the idle period of that FFP is also associated to the gNB initiated COT, and the UE 412 does not transmit any UL transmission or expect to receive any DL transmission in the corresponding idle period.

In one option, if a first UL transmission is associated to the UE initiated COT in an FFP, a second UL transmission starting in that FFP scheduled by a DCI can be indicated with gNB initiated COT for the second UL transmission, and the UE 412 does not transmit any UL transmission or expect to receive any DL transmission in the corresponding idle period. In another example, if a first UL transmission is associated to the gNB initiated COT in an FFP, a second UL transmission starting in that FFP scheduled by a DCI can be indicated by the DCI indicating UE initiated COT for the second UL transmission, and the UE 412 does not transmit any UL transmission in the corresponding idle period.

In one option, the UE 412 chooses the COT priority autonomously (between gNB-initiated COT and UE-initiated COT) for an UL transmission.

In another option, if the UE 412 chooses the COT priority autonomously (between gNB-initiated COT and UE-initiated COT) for an UL transmission, the UE 412 indicates the priority to the gNB 402 (e.g., in an Uplink Control Information (UCI), e.g., CG-UCI).

In one option, the UE 412 chooses the COT priority between gNB-initiated COT and UE-initiated for an UL transmission based on some implicit rule (in agreement with gNB 402). For example, the UE 412 always prefer to transmit in the COT having a lesser amount idle period (i.e., a smaller idle period) when both COTs are available for transmission.

In one option, if a COT is prioritized, the prioritization would uphold for a certain time period/counter. After that time expires, the UE 412 is provided a new update with the priority among the COTs (between gNB-initiated COT and UE-initiated COT).

In one option, the UE 412 can send a request (e.g., via UCI) for COT priority from gNB 402. The request (e.g., UCI including the request) can be sent on Physical Uplink Control Channel (PUCCH) or multiplexed with PUSCH.

In one option, the UE 412 can be configured/allocated with multiple FFPs (UE-FFPs), and therefore different priorities can be configured or set for among all FFPs (multiple UE-FFPs and gNB-FFP). All the above options (UE is allocated with one UE-FFP) can be reproduced here.

In one option, both idle periods (from gNB-FFP and UE-FFP) are excluded from DL preemption reference resource, and UL cancellation reference resource. This is in extension to a known solution, where only one FFP (gNB-FFP) is considered.

In one option, if both FFPs are configured for the UE 412, then both idle periods (from gNB-FFP and UE-FFP) are included in DL preemption reference resource, and UL cancellation reference resource. This is because the gNB 402 may not know at a point of time where the UE 412 is utilizing gNB-FFP or UE-FFP.

In one option, if both FFPs are configured for the UE 412, then the idle period of gNB-FFP only is deemed invalid and thus excluded from DL preemption reference resource and UL cancellation reference resource. This is because the gNB 402 has greater control over gNB-FFP than UE-FFP (as it's initiated by the UE 412), and thus the gNB 412 perhaps interested in not sending DL preemption indicator or UL cancellation indication in the idle period of its FFP, i.e., gNB-FFP.

In another embodiment, the option of following gNB-initiated COT or UE-initiated COT depends on the UL transmission type. The UL transmission type may include: dynamically scheduled PUSCH, UL CG PUSCH, Physical Random Access Channel (PRACH), Msg3 in four-step Random Access Channel (RACH), MsgB in two-step RACH, PUCCH, or Sounding Reference Signal (SRS).
For example, dynamically scheduled PUSCH can follow either gNB-initiated COT or UE-initiated COT, while UL CG PUSCH always follows gNB-initiated COT.
For example, Msg3 in four-step RACH and MsgB in two-step RACH always follow gNB-initiated COT.

In another embodiment, the option of following gNB-initiated COT or UE-initiated COT can depend on the time-domain characteristics of the intended UL transmission.
For example, periodically scheduled UL transmissions always follow gNB-initiated COT, where the periodic UL transmissions include periodic Channel State Information (CSI) on PUCCH, periodic SRS, UL CG PUSCH.
For example, semi-persistently scheduled UL transmissions always follow gNB-initiated COT, where the semi-persistent UL transmissions include: semi-persistent CSI reporting (on PUCCH or PUSCH), semi-persistent SRS.
For example, dynamically scheduled PUSCH, aperiodic CSI reporting, aperiodic SRS can follow either gNB-initiated COT or UE-initiated COT.

In another embodiment, the option of following gNB-initiated COT or UE-initiated COT can depend on the urgency or importance of the UL transmission.
For example, PDCCH-ordered PRACH use different option than PRACH triggered by upper layer request.
For example, UL transmission (PUCCH or PUSCH) with higher physical layer priority use a different option than UL transmission (PUCCH or PUSCH) with lower physical layer priority.

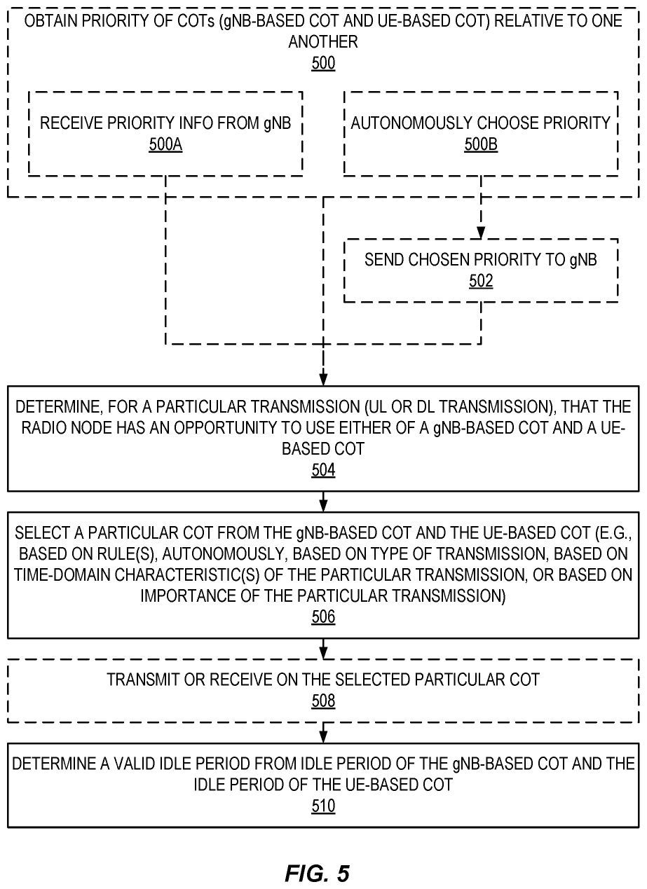

FIG. 5 is a flow chart that illustrates the operation of a radio node in accordance with at least some embodiments of the present disclosure. The radio node may be the gNB 402 or the UE 412. Optional steps are represented by dashed lines/boxes. Further, the illustrated steps may be performed in any order unless otherwise explicitly stated or required. As illustrated, the radio node may obtain a priority of a gNB-initiated COT and a UE-initiated COT relative to one another when the radio node has an opportunity to use either one of a gNB-initiated COT and a UE-initiated COT (step 500). As described above, in one embodiment, the radio node is the UE 412, and the UE 412 obtains this information from the gNB 402 (step 500A). In another embodiment, the radio node autonomously determines the priority of a gNB-initiated COT and a UE-initiated COT relative to one another, as also described above (step 500B). For example, in one embodiment, the radio node is the UE 412, and the UE 412 autonomously determines priority of the of a gNB-initiated COT and a UE-initiated COT relative to one another and may then send information that indicates this priority to the gNB 402 (step 502).

As discussed above, for a particular transmission (i.e., a particular UL transmission or a particular DL transmission), the radio node determines that the radio node has an opportunity to transmit or receive in either of two COTs, namely, a gNB-initiated COT and a UE-initiated COT (step 504). For example, if the radio node is the UE 412 and the particular transmission is a particular UL transmission, the UE 412 determines that the UE 412 has an opportunity to transmit the particular UL transmission in either a gNB-initiated COT or a UE-initiated COT. In other words, both a gNB-initiated COT and a UE-initiated COT are available for use.

Responsive to the determination made in step 504, the radio node selects a particular COT from among the gNB-initiated COT and the UE-initiated COT to be used for the particular transmission (step 506). The radio node then transmits or receives the particular transmission in the selected COT (step 508). The radio node also determines that an idle period associated to the selected COT is a valid idle period, as discussed above (step 510). Note that the details provided above about how the radio node selects which of the COTs to use and selects the valid idle period are equally applicable here to step 506 and 510.

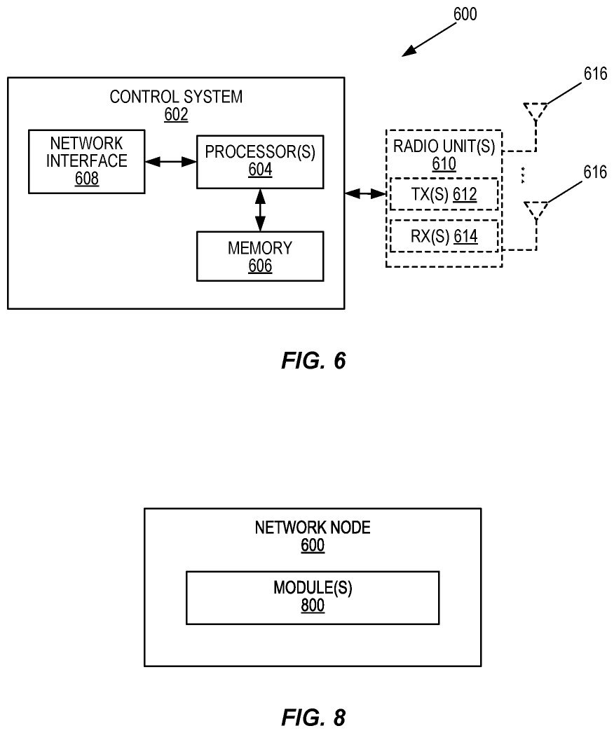

FIG. 6 is a schematic block diagram of a network node 600 according to some embodiments of the present disclosure. Optional features are represented by dashed boxes. The network node 600 may be, for example, a base station 402 or 406 or a network node that implements all or part of the functionality of the base station 402 or gNB described herein. As illustrated, the network node 600 includes a control system 602 that includes one or more processors 604 (e.g., Central Processing Units (CPUs), Application Specific Integrated Circuits (ASICs), Field Programmable Gate Arrays (FPGAs), and/or the like), memory 606, and a network interface 608. The one or more processors 604 are also referred to herein as processing circuitry. In addition, the network node 600 may include one or more radio units 610 that each includes one or more transmitters 612 and one or more receivers 614 coupled to one or more antennas 616. The radio units 610 may be referred to or be part of radio interface circuitry. In some embodiments, the radio unit(s) 610 is external to the control system 602 and connected to the control system 602 via, e.g., a wired connection (e.g., an optical cable). However, in some other embodiments, the radio unit(s) 610 and potentially the antenna(s) 616 are integrated together with the control system 602. The one or more processors 604 operate to provide one or more functions of the network node 600 as described herein (e.g., one or more functions of the gNB 402 as described herein). In some embodiments, the function(s) are implemented in software that is stored, e.g., in the memory 606 and executed by the one or more processors 604.

FIG. 7 is a schematic block diagram that illustrates a virtualized embodiment of the network node 600 according to some embodiments of the present disclosure. Again, optional features are represented by dashed boxes. As used herein, a “virtualized” network node is an implementation of the network node 600 in which at least a portion of the functionality of the network node 600 is implemented as a virtual component(s) (e.g., via a virtual machine(s) executing on a physical processing node(s) in a network(s)). As illustrated, in this example, the network node 600 may include the control system 602 and/or the one or more radio units 610, as described above. The control system 602 may be connected to the radio unit(s) 610 via, for example, an optical cable or the like. The network node 600 includes one or more processing nodes 700 coupled to or included as part of a network(s) 702. If present, the control system 602 or the radio unit(s) are connected to the processing node(s) 700 via the network 702. Each processing node 700 includes one or more processors 704 (e.g., CPUs, ASICs, FPGAs, and/or the like), memory 706, and a network interface 708.

In this example, functions 710 of the network node 600 described herein (e.g., one or more functions of the gNB 402 as described herein) are implemented at the one or more processing nodes 700 or distributed across the one or more processing nodes 700 and the control system 602 and/or the radio unit(s) 610 in any desired manner In some particular embodiments, some or all of the functions 710 of the network node 600 described herein (e.g., one or more functions of the gNB 402 as described herein) are implemented as virtual components executed by one or more virtual machines implemented in a virtual environment(s) hosted by the processing node(s) 700. As will be appreciated by one of ordinary skill in the art, additional signaling or communication between the processing node(s) 700 and the control system 602 may be used in order to carry out at least some of the desired functions 710. Notably, in some embodiments, the control system 602 may not be included, in which case the radio unit(s) 610 communicate directly with the processing node(s) 700 via an appropriate network interface(s).

In some embodiments, a computer program including instructions which, when executed by at least one processor, causes the at least one processor to carry out the functionality of the network node 600 or a node (e.g., a processing node 700) implementing one or more of the functions 710 of the network node 600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the network node 600 according to some other embodiments of the present disclosure. The network node 600 includes one or more modules 800, each of which is implemented in software. The module(s) 800 provide the functionality of the network node 600 described herein (e.g., one or more functions of the gNB 402 as described herein). This discussion is equally applicable to the processing node 700 of FIG. 7 where the modules 800 may be implemented at one of the processing nodes 700 or distributed across multiple processing nodes 700 and/or distributed across the processing node(s) 700 and the control system 602.

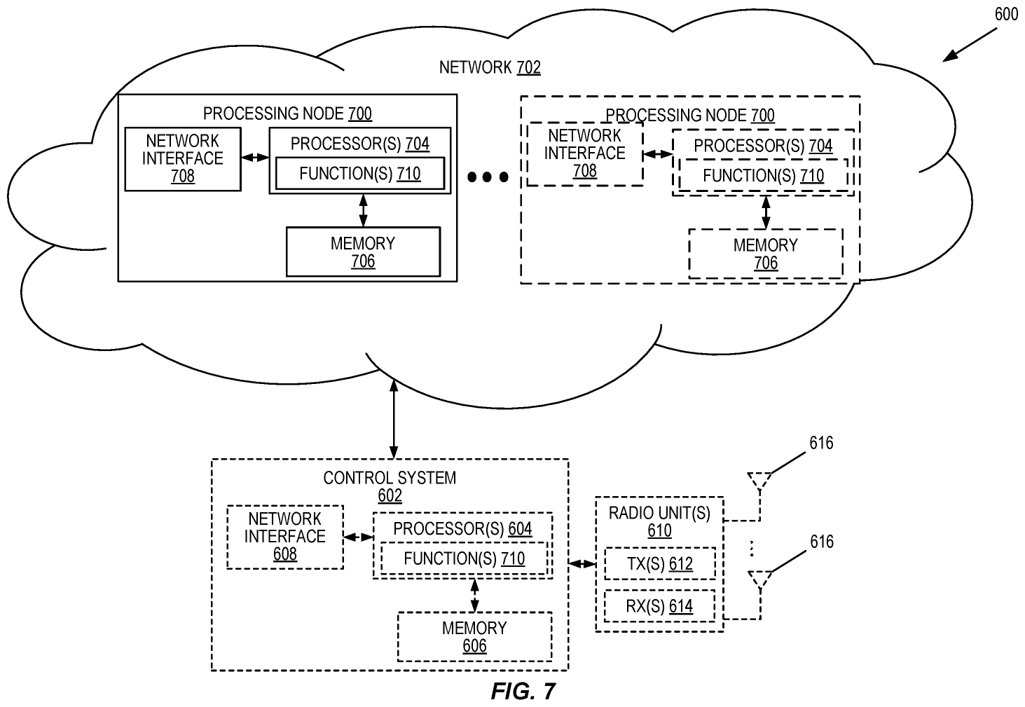

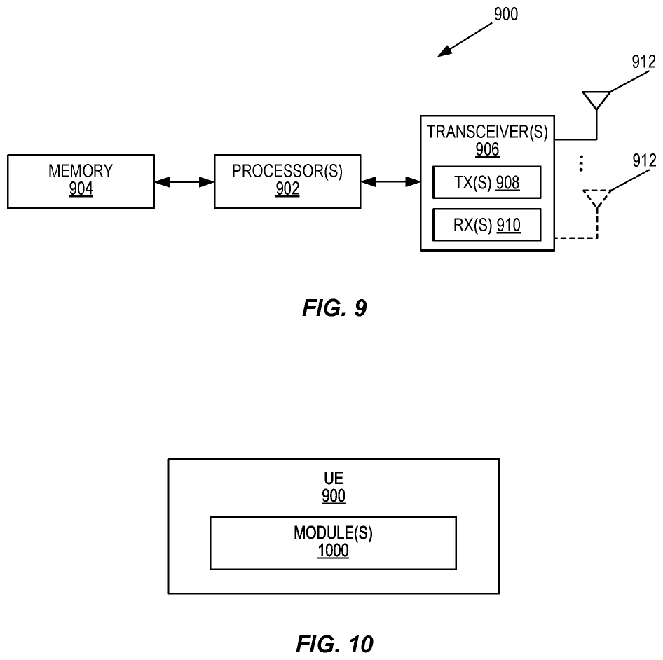

FIG. 9 is a schematic block diagram of a wireless communication device 900 (e.g., the UE 412) according to some embodiments of the present disclosure. As illustrated, the wireless communication device 900 includes one or more processors 902 (e.g., CPUs, ASICs, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the wireless communication device 900 described above (e.g., one or more functions of the UE 412 as described herein) may be fully or partially implemented in software that is, e.g., stored in the memory 904 and executed by the processor(s) 902. Note that the wireless communication device 900 may include additional components not illustrated in FIG. 9 such as, e.g., one or more user interface components (e.g., an input/output interface including a display, buttons, a touch screen, a microphone, a speaker(s), and/or the like and/or any other components for allowing input of information into the wireless communication device 900 and/or allowing output of information from the wireless communication device 900), a power supply (e.g., a battery and associated power circuitry), etc.

In some embodiments, a computer program including instructions which, when executed by at least one processor, causes the at least one processor to carry out the functionality of the wireless communication device 900 according to any of the embodiments described herein (e.g., one or more functions of the UE 412 as described herein) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the wireless communication device 900 according to some other embodiments of the present disclosure. The wireless communication device 900 includes one or more modules 1000, each of which is implemented in software. The module(s) 1000 provide the functionality of the wireless communication device 900 described herein (e.g., one or more functions of the UE 412 as described herein).

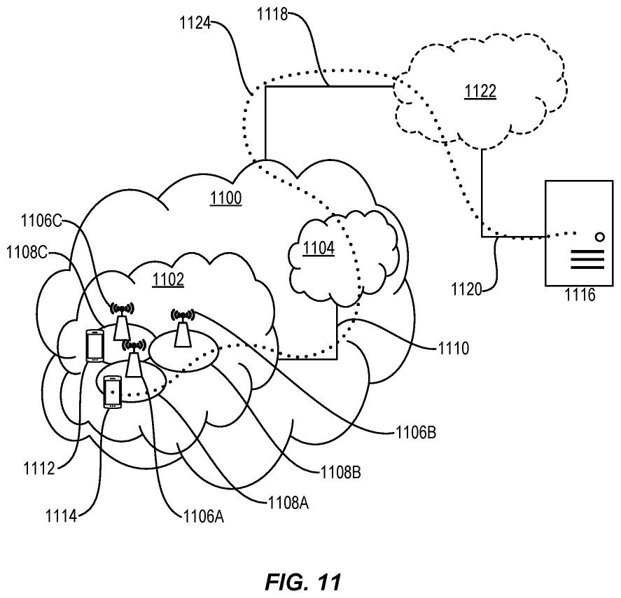

With reference to FIG. 11, in accordance with an embodiment, a communication system includes a telecommunication network 1100, such as a 3GPP-type cellular network, which comprises an access network 1102, such as a RAN, and a core network 1104. The access network 1102 comprises a plurality of base stations 1106A, 1106B, 1106C, such as Node Bs, eNBs, gNBs, or other types of wireless Access Points (APs), each defining a corresponding coverage area 1108A, 1108B, 1108C. Each base station 1106A, 1106B, 1106C is connectable to the core network 1104 over a wired or wireless connection 1110. A first UE 1112 located in coverage area 1108C is configured to wirelessly connect to, or be paged by, the corresponding base station 1106C. A second UE 1114 in coverage area 1108A is wirelessly connectable to the corresponding base station 1106A. While a plurality of UEs 1112, 1114 are illustrated in this example, the disclosed embodiments are equally applicable to a situation where a sole UE is in the coverage area or where a sole UE is connecting to the corresponding base station 1106.

The telecommunication network 1100 is itself connected to a host computer 1116, which may be embodied in the hardware and/or software of a standalone server, a cloud-implemented server, a distributed server, or as processing resources in a server farm. The host computer 1116 may be under the ownership or control of a service provider, or may be operated by the service provider or on behalf of the service provider. Connections 1118 and 1120 between the telecommunication network 1100 and the host computer 1116 may extend directly from the core network 1104 to the host computer 1116 or may go via an optional intermediate network 1122. The intermediate network 1122 may be one of, or a combination of more than one of, a public, private, or hosted network; the intermediate network 1122, if any, may be a backbone network or the Internet; in particular, the intermediate network 1122 may comprise two or more sub-networks (not shown).

The communication system of FIG. 11 as a whole enables connectivity between the connected UEs 1112, 1114 and the host computer 1116. The connectivity may be described as an Over-the-Top (OTT) connection 1124. The host computer 1116 and the connected UEs 1112, 1114 are configured to communicate data and/or signaling via the OTT connection 1124, using the access network 1102, the core network 1104, any intermediate network 1122, and possible further infrastructure (not shown) as intermediaries. The OTT connection 1124 may be transparent in the sense that the participating communication devices through which the OTT connection 1124 passes are unaware of routing of uplink and downlink communications. For example, the base station 1106 may not or need not be informed about the past routing of an incoming downlink communication with data originating from the host computer 1116 to be forwarded (e.g., handed over) to a connected UE 1112. Similarly, the base station 1106 need not be aware of the future routing of an outgoing uplink communication originating from the UE 1112 towards the host computer 1116.

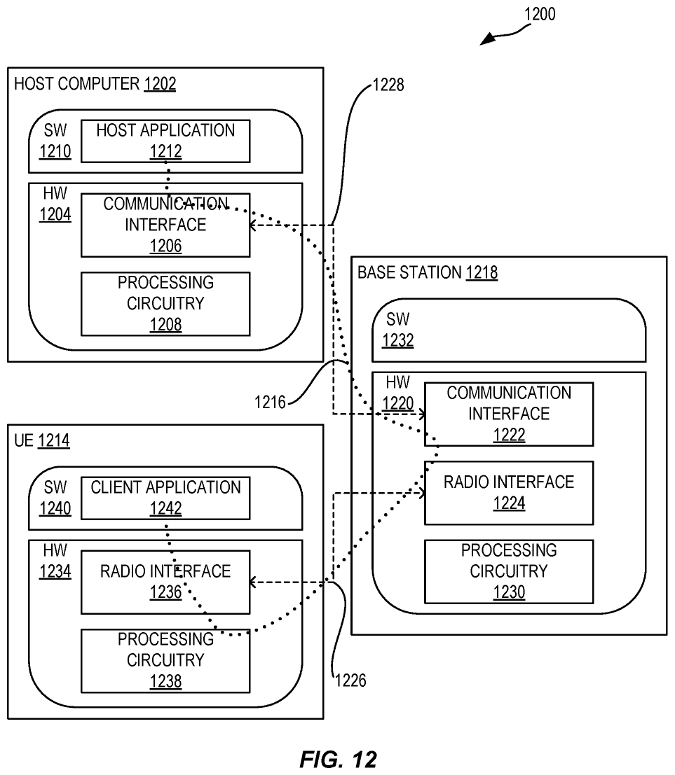

Example implementations, in accordance with an embodiment, of the UE, base station, and host computer discussed in the preceding paragraphs will now be described with reference to FIG. 12. In a communication system 1200, a host computer 1202 comprises hardware 1204 including a communication interface 1206 configured to set up and maintain a wired or wireless connection with an interface of a different communication device of the communication system 1200. The host computer 1202 further comprises processing circuitry 1208, which may have storage and/or processing capabilities. In particular, the processing circuitry 1208 may comprise one or more programmable processors, ASICs, FPGAs, or combinations of these (not shown) adapted to execute instructions. The host computer 1202 further comprises software 1210, which is stored in or accessible by the host computer 1202 and executable by the processing circuitry 1208. The software 1210 includes a host application 1212. The host application 1212 may be operable to provide a service to a remote user, such as a UE 1214 connecting via an OTT connection 1216 terminating at the UE 1214 and the host computer 1202. In providing the service to the remote user, the host application 1212 may provide user data which is transmitted using the OTT connection 1216.

The communication system 1200 further includes a base station 1218 provided in a telecommunication system and comprising hardware 1220 enabling it to communicate with the host computer 1202 and with the UE 1214. The hardware 1220 may include a communication interface 1222 for setting up and maintaining a wired or wireless connection with an interface of a different communication device of the communication system 1200, as well as a radio interface 1224 for setting up and maintaining at least a wireless connection 1226 with the UE 1214 located in a coverage area (not shown in FIG. 12) served by the base station 1218. The communication interface 1222 may be configured to facilitate a connection 1228 to the host computer 1202. The connection 1228 may be direct or it may pass through a core network (not shown in FIG. 12) of the telecommunication system and/or through one or more intermediate networks outside the telecommunication system. In the embodiment shown, the hardware 1220 of the base station 1218 further includes processing circuitry 1230, which may comprise one or more programmable processors, ASICs, FPGAs, or combinations of these (not shown) adapted to execute instructions. The base station 1218 further has software 1232 stored internally or accessible via an external connection.

The communication system 1200 further includes the UE 1214 already referred to. The UE's 1214 hardware 1234 may include a radio interface 1236 configured to set up and maintain a wireless connection 1226 with a base station serving a coverage area in which the UE 1214 is currently located. The hardware 1234 of the UE 1214 further includes processing circuitry 1238, which may comprise one or more programmable processors, ASICs, FPGAs, or combinations of these (not shown) adapted to execute instructions. The UE 1214 further comprises software 1240, which is stored in or accessible by the UE 1214 and executable by the processing circuitry 1238. The software 1240 includes a client application 1242. The client application 1242 may be operable to provide a service to a human or non-human user via the UE 1214, with the support of the host computer 1202. In the host computer 1202, the executing host application 1212 may communicate with the executing client application 1242 via the OTT connection 1216 terminating at the UE 1214 and the host computer 1202. In providing the service to the user, the client application 1242 may receive request data from the host application 1212 and provide user data in response to the request data. The OTT connection 1216 may transfer both the request data and the user data. The client application 1242 may interact with the user to generate the user data that it provides.

It is noted that the host computer 1202, the base station 1218, and the UE 1214 illustrated in FIG. 12 may be similar or identical to the host computer 1116, one of the base stations 1106A, 1106B, 1106C, and one of the UEs 1112, 1114 of FIG. 11, respectively. This is to say, the inner workings of these entities may be as shown in FIG. 12 and independently, the surrounding network topology may be that of FIG. 11.

In FIG. 12, the OTT connection 1216 has been drawn abstractly to illustrate the communication between the host computer 1202 and the UE 1214 via the base station 1218 without explicit reference to any intermediary devices and the precise routing of messages via these devices. The network infrastructure may determine the routing, which may be configured to hide from the UE 1214 or from the service provider operating the host computer 1202, or both. While the OTT connection 1216 is active, the network infrastructure may further take decisions by which it dynamically changes the routing (e.g., on the basis of load balancing consideration or reconfiguration of the network).

The wireless connection 1226 between the UE 1214 and the base station 1218 is in accordance with the teachings of the embodiments described throughout this disclosure. One or more of the various embodiments improve the performance of OTT services provided to the UE 1214 using the OTT connection 1216, in which the wireless connection 1226 forms the last segment.

A measurement procedure may be provided for the purpose of monitoring data rate, latency, and other factors on which the one or more embodiments improve. There may further be an optional network functionality for reconfiguring the OTT connection 1216 between the host computer 1202 and the UE 1214, in response to variations in the measurement results. The measurement procedure and/or the network functionality for reconfiguring the OTT connection 1216 may be implemented in the software 1210 and the hardware 1204 of the host computer 1202 or in the software 1240 and the hardware 1234 of the UE 1214, or both. In some embodiments, sensors (not shown) may be deployed in or in association with communication devices through which the OTT connection 1216 passes; the sensors may participate in the measurement procedure by supplying values of the monitored quantities exemplified above, or supplying values of other physical quantities from which the software 1210, 1240 may compute or estimate the monitored quantities. The reconfiguring of the OTT connection 1216 may include message format, retransmission settings, preferred routing, etc.; the reconfiguring need not affect the base station 1218, and it may be unknown or imperceptible to the base station 1218. Such procedures and functionalities may be known and practiced in the art. In certain embodiments, measurements may involve proprietary UE signaling facilitating the host computer 1202's measurements of throughput, propagation times, latency, and the like. The measurements may be implemented in that the software 1210 and 1240 causes messages to be transmitted, in particular empty or ‘dummy’ messages, using the OTT connection 1216 while it monitors propagation times, errors, etc.

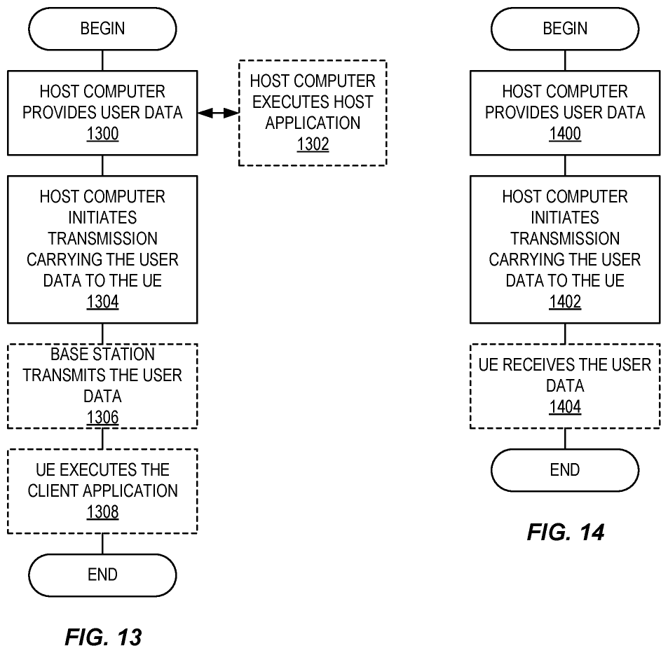

FIG. 13 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 13 will be included in this section. In step 1300, the host computer provides user data. In sub-step 1302 (which may be optional) of step 1300, the host computer provides the user data by executing a host application. In step 1304, the host computer initiates a transmission carrying the user data to the UE. In step 1306 (which may be optional), the base station transmits to the UE the user data which was carried in the transmission that the host computer initiated, in accordance with the teachings of the embodiments described throughout this disclosure. In step 1308 (which may also be optional), the UE executes a client application associated with the host application executed by the host computer.

FIG. 14 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 14 will be included in this section. In step 1400 of the method, the host computer provides user data. In an optional sub-step (not shown) the host computer provides the user data by executing a host application. In step 1402, the host computer initiates a transmission carrying the user data to the UE. The transmission may pass via the base station, in accordance with the teachings of the embodiments described throughout this disclosure. In step 1404 (which may be optional), the UE receives the user data carried in the transmission.

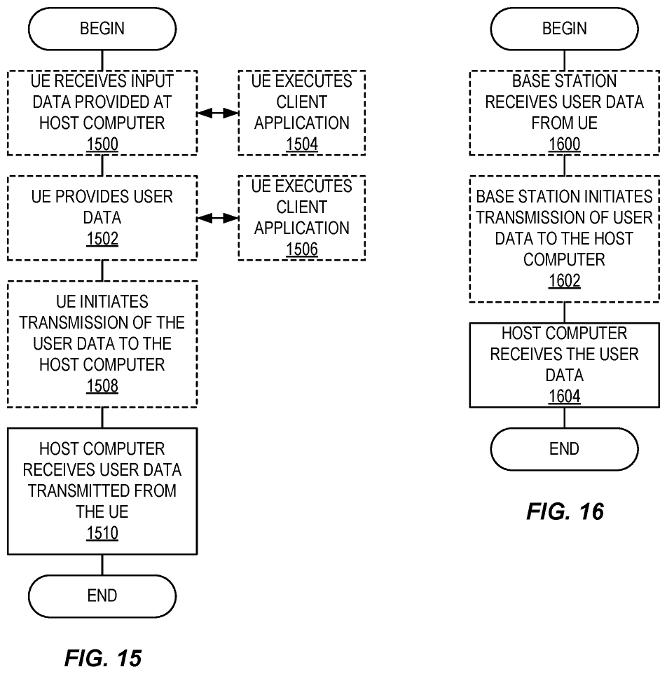

FIG. 15 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 15 will be included in this section. In step 1500 (which may be optional), the UE receives input data provided by the host computer. Additionally or alternatively, in step 1502, the UE provides user data. In sub-step 1504 (which may be optional) of step 1500, the UE provides the user data by executing a client application. In sub-step 1506 (which may be optional) of step 1502, the UE executes a client application which provides the user data in reaction to the received input data provided by the host computer. In providing the user data, the executed client application may further consider user input received from the user. Regardless of the specific manner in which the user data was provided, the UE initiates, in sub-step 1508 (which may be optional), transmission of the user data to the host computer. In step 1510 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 16 will be included in this section. In step 1600 (which may be optional), in accordance with the teachings of the embodiments described throughout this disclosure, the base station receives user data from the UE. In step 1602 (which may be optional), the base station initiates transmission of the received user data to the host computer. In step 1604 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:
Embodiment 1: A method performed by a radio node (e.g., a wireless communication device 412 or base station 402), the method comprising one or more of the following actions:
   determining (504), for a particular transmission, that the radio node (412; 402) has an opportunity to use either of two channel occupancy times, COTs, consisting of a base station initiated COT and a wireless device initiated COT;
   responsive to determining (504) that the radio node (412; 402) has an opportunity to use either of the two COTs, selecting (506) a particular COT from among the two COTs to be used for the particular transmission;
   determining (510) that an idle period associated to the particular COT is a valid idle period in which no transmissions to or from the radio node (412; 402) are to occur.
Embodiment 2: The method of embodiment 1 wherein selecting (506) the particular COT from among the two COTs comprises selecting (506) the particular COT from among the two COTs based on one or more predefined rules.
Embodiment 3: The method of embodiment 2 wherein the one or more predefined rules comprise a rule that is based on priority of the two COTs relative to one another.
Embodiment 4: The method of embodiment 3 wherein the radio node (412) is a wireless communication device (412), and the method further comprises receiving (500A) information from a base station (402) that indicates the priority of the base station initiated COT relative to that of the wireless device initiated COT.
Embodiment 5: The method of embodiment 4 wherein receiving (500A) the information comprises receiving (5BB) the information via DCI, CG or DL SPS activation or release DCI, RRC configuration, a new DCI signaling to indicate changes in COT priority, PDSCH, or SIB signaling.
Embodiment 6: The method of any of embodiments 3 to 5 wherein the rule that is based on the priority of the two COTs relative to one other is a rule that a highest priority COT of the two COTs is to be considered by the radio node (412; 402) first when the radio node (412; 402) has an opportunity to use either of the two COTs.
Embodiment 7: The method of embodiment 6 wherein the rule is further that a lowest priority COT of the two COTs is to be considered by the radio node (412; 402) only if the idle period associated to the highest priority COT occurs during the particular transmission.
Embodiment 8: The method of any of embodiments 2 to 7 wherein the radio node (412) is a wireless communication device (412), the particular transmission is an UL transmission, and the one or more rules comprise a rule that if the UL transmission starts at a beginning of an FFP associated to the wireless communication device (412) and ends before the idle period associated to that FFP, the wireless device initiated COT is to be selected or considered first for the particular transmission.
Embodiment 9: The method of any of embodiments 2 to 7 wherein the radio node (412) is a wireless communication device (412), the particular transmission is an UL transmission, and the one or more rules comprise a rule that if the UL transmission starts at a beginning of an FFP associated to a base station (402) associated to the base station initiated COT and ends before the idle period associated to that FFP and the wireless communication device (412) has already determined that the base station initiated COT is initiated, the base station initiated COT is to be selected or considered first for the particular transmission.
Embodiment 10: The method of any of embodiments 2 to 7 wherein the radio node (412) is a wireless communication device (412), the particular transmission is an DL transmission, and the one or more rules comprise a rule that if the DL transmission starts within an FFP associated to a base station (402) associated to the base station initiated COT and ends before the idle period associated to that FFP, the base station initiated COT is to be selected or considered first for the particular transmission.
Embodiment 11: The method of any of embodiments 2 to 7 wherein the radio node (412) is a wireless communication device (412), the particular transmission is a second UL transmission that is subsequent to a first UL transmission associated to the wireless device initiated COT in an FFP, and the one or more rules comprise a rule that the second UL transmission is also associated to the wireless device initiated COT if the second UL transmission ends before the idle period of the FFP.
Embodiment 12: The method of any of embodiments 2 to 7 wherein the radio node (412) is a wireless communication device (412), the particular transmission is a second UL transmission that is subsequent to a first UL transmission associated to the base station initiated COT in an FFP, and the one or more rules comprise a rule that the second UL transmission is also associated to the base station initiated COT if the second UL transmission ends before the idle period of the FFP.
Embodiment 13: The method of embodiment 1 wherein the radio node (412; 402) is a wireless communication device (412), the particular transmission is an UL transmission, and selecting (506) the particular COT from among the two COTs comprises selecting (506) the particular COT from among the two COTs autonomously.
Embodiment 14: The method of embodiment 13 further comprising sending (502), to a base station (402) associated to the base station initiated COT, information that indicates a priority of the two COTs relative to one another.
Embodiment 15: The method of embodiment 3 wherein the radio node (412) is a wireless communication device (412), and the method further comprises choosing (500B) the priority of the two COTs relative to one another.
Embodiment 16: The method of embodiment 15 wherein choosing (500B) the priority of the two COTs relative to one another comprises choosing (500B) the priority of the two COTs relative to one another based on a rule.
Embodiment 17: The method of embodiment 15 wherein choosing (500B) the priority of the two COTs relative to one another comprises choosing (500B) the priority of the two COTs relative to one another based on durations of respective idle periods for the two COTs.
Embodiment 18: The method of any of embodiments 1 to 17 wherein the radio node (412) is a wireless communication device (412), and the wireless communication device (412) is configured with two or more FFPs.
Embodiment 19: The method of embodiment 18 wherein idle periods from one or more FFPs of a base station (402) and idle periods of the two or more FFPs of the wireless communication device (412) are excluded from a DL preemption resource and/or an UL cancellation reference resource.
Embodiment 20: The method of embodiment 18 wherein idle periods from the two or more FFPs of the wireless communication device (412) are included in a DL preemption resource and/or an UL cancellation reference resource.
Embodiment 21: The method of embodiment 18 wherein idle periods from one or more FFPs of a base station (402), but not idle periods of the two or more FFPs of the wireless communication device (412), are excluded from a DL preemption resource and/or an UL cancellation reference resource.
Embodiment 22: The method of embodiment 1 wherein the radio node (412) is a wireless communication device (412), the particular transmission is an UL transmission, and selecting (506) the particular COT comprises selecting (506) the particular COT from among the two COTs to be used for the UL transmission based on an UL transmission type of the UL transmission.
Embodiment 23: The method of embodiment 1 wherein the radio node (412) is a wireless communication device (412), the particular transmission is an UL transmission, and selecting (506) the particular COT comprises selecting (506) the particular COT from among the two COTs to be used for the UL transmission based on one or more time-domain characteristics of the UL transmission.
Embodiment 24: The method of embodiment 1 wherein the radio node (412) is a wireless communication device (412), the particular transmission is an UL transmission, and selecting (506) the particular COT comprises selecting (506) the particular COT from among the two COTs to be used for the UL transmission based on an importance of the UL transmission.
Embodiment 25: The method of any of embodiments 1 to 24 further comprising transmitting or receiving (508) the particular transmission in the particular COT.
Embodiment 26: The method of any of the previous embodiments, wherein the radio node (412) is a wireless communication device (412), and the method further comprises:
   providing user data; and
   forwarding the user data to a host computer via the transmission to the base station.
Embodiment 27: The method of any of embodiments 1-3, 6, 7, and 25, wherein the radio node (402) is a base station (402), and the method further comprises:
   obtaining user data; and
   forwarding the user data to a host computer or a wireless device.
Embodiment 28: A wireless device comprising:
   processing circuitry configured to perform any of the steps of any of any of embodiments 1 to 26; and
   power supply circuitry configured to supply power to the wireless device.
Embodiment 29: A base station comprising:
   processing circuitry configured to perform any of the steps of any of embodiments 1-3, 6, 7, 25, and 27; and
   power supply circuitry configured to supply power to the base station.
Embodiment 30: A User Equipment, UE, comprising:
   an antenna configured to send and receive wireless signals;
   radio front-end circuitry connected to the antenna and to processing circuitry, and configured to condition signals communicated between the antenna and the processing circuitry;
the processing circuitry being configured to perform any of the steps of any of any of embodiments 1 to 26;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
Embodiment 31: A communication system including a host computer comprising:
   processing circuitry configured to provide user data; and
   a communication interface configured to forward the user data to a cellular network for transmission to a User Equipment, UE;
   wherein the cellular network comprises a base station having a radio interface and processing circuitry, the base station's processing circuitry configured to perform any of the steps of any of embodiments 1-3, 6, 7, 25, and 27.
Embodiment 32: The communication system of the previous embodiment further including the base station.
Embodiment 33: The communication system of the previous 2 embodiments, further including the UE, wherein the UE is configured to communicate with the base station.
Embodiment 34: The communication system of the previous 3 embodiments, wherein:
   the processing circuitry of the host computer is configured to execute a host application, thereby providing the user data; and
   the UE comprises processing circuitry configured to execute a client application associated with the host application.
Embodiment 35: A method implemented in a communication system including a host computer, a base station, and a User Equipment, UE, the method comprising:
   at the host computer, providing user data; and
   at the host computer, initiating a transmission carrying the user data to the UE via a cellular network comprising the base station, wherein the base station performs any of the steps of any of embodiments 1-3, 6, 7, 25, and 27.
Embodiment 36: The method of the previous embodiment, further comprising, at the base station, transmitting the user data.
Embodiment 37: The method of the previous 2 embodiments, wherein the user data is provided at the host computer by executing a host application, the method further comprising, at the UE, executing a client application associated with the host application.
Embodiment 38: A User Equipment, UE, configured to communicate with a base station, the UE comprising a radio interface and processing circuitry configured to perform the method of the previous 3 embodiments.
Embodiment 39: A communication system including a host computer comprising:
   processing circuitry configured to provide user data; and
   a communication interface configured to forward user data to a cellular network for transmission to a User Equipment, UE;
   wherein the UE comprises a radio interface and processing circuitry, the UE's components configured to perform any of the steps of any of embodiments 1 to 26.
Embodiment 40: The communication system of the previous embodiment, wherein the cellular network further includes a base station configured to communicate with the UE.
Embodiment 41: The communication system of the previous 2 embodiments, wherein:
   the processing circuitry of the host computer is configured to execute a host application, thereby providing the user data; and
   the UE's processing circuitry is configured to execute a client application associated with the host application.
Embodiment 42: A method implemented in a communication system including a host computer, a base station, and a User Equipment, UE, the method comprising:
   at the host computer, providing user data; and
   at the host computer, initiating a transmission carrying the user data to the UE via a cellular network comprising the base station, wherein the UE performs any of the steps of any of embodiments 1 to 26.
Embodiment 43: The method of the previous embodiment, further comprising at the UE, receiving the user data from the base station.
Embodiment 44: A communication system including a host computer comprising:
   communication interface configured to receive user data originating from a transmission from a User Equipment, UE, to a base station;
   wherein the UE comprises a radio interface and processing circuitry, the UE's processing circuitry configured to perform any of the steps of any of any of embodiments 1 to 26.
Embodiment 45: The communication system of the previous embodiment, further including the UE.
Embodiment 46: The communication system of the previous 2 embodiments, further including the base station, wherein the base station comprises a radio interface configured to communicate with the UE and a communication interface configured to forward to the host computer the user data carried by a transmission from the UE to the base station.
Embodiment 47: The communication system of the previous 3 embodiments, wherein:
   the processing circuitry of the host computer is configured to execute a host application; and
   the UE's processing circuitry is configured to execute a client application associated with the host application, thereby providing the user data.
Embodiment 48: The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
Embodiment 49: A method implemented in a communication system including a host computer, a base station, and a User Equipment, UE, the method comprising:
   at the host computer, receiving user data transmitted to the base station from the UE, wherein the UE performs any of the steps of any of any of embodiments 1 to 26.
Embodiment 50: The method of the previous embodiment, further comprising, at the UE, providing the user data to the base station.
Embodiment 51: The method of the previous 2 embodiments, further comprising:
   at the UE, executing a client application, thereby providing the user data to be transmitted; and
   at the host computer, executing a host application associated with the client application.
Embodiment 52: The method of the previous 3 embodiments, further comprising:
   at the UE, executing a client application; and
   at the UE, receiving input data to the client application, the input data being provided at the host computer by executing a host application associated with the client application;
   wherein the user data to be transmitted is provided by the client application in response to the input data.
Embodiment 53: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of embodiments 1-3, 6, 7, 25, and 27.
Embodiment 54: The communication system of the previous embodiment further including the base station.
Embodiment 55: The communication system of the previous 2 embodiments, further including the UE, wherein the UE is configured to communicate with the base station.
Embodiment 56: The communication system of the previous 3 embodiments, wherein:
   the processing circuitry of the host computer is configured to execute a host application; and
   the UE is configured to execute a client application associated with the host application, thereby providing the user data to be received by the host computer.
Embodiment 57: A method implemented in a communication system including a host computer, a base station, and a User Equipment, UE, the method comprising:
   at the host computer, receiving, from the base station, user data originating from a transmission which the base station has received from the UE, wherein the UE performs any of the steps of any of any of embodiments 1 to 26.
Embodiment 58: The method of the previous embodiment, further comprising at the base station, receiving the user data from the UE.
Embodiment 59: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a radio node, the method comprising:
determining, for a particular transmission, that the radio node has an opportunity to use either of two channel occupancy times (COTs) consisting of a base station initiated COT and a wireless device initiated COT;
responsive to determining that the radio node has an opportunity to use either of the two COTs, selecting a particular COT from among the two COTs to be used for the particular transmission; and
determining that an idle period associated to the particular COT is a valid idle period in which no transmissions to or from the radio node are to occur.

2. The method of claim 1 wherein selecting the particular COT from among the two COTs comprises selecting the particular COT from among the two COTs based on one or more predefined rules.

3. The method of claim 2 wherein the one or more predefined rules comprise a rule that is based on priority of the two COTs relative to one another.

4. The method of claim 3 wherein the radio node is a wireless communication device, and the method further comprises receiving information from a base station that indicates the priority of the base station initiated COT relative to that of the wireless device initiated COT.

5. The method of claim 4 wherein receiving the information comprises receiving the information via:
downlink control information (DCI);
downlink, DL, semi-persistent scheduling, SPS, activation or release DCI;
radio resource control, RRC, configuration;
a new DCI signaling to indicate changes in COT priority;
physical downlink shared channel (PDSCH); or
system information block (SIB) signaling.

6. The method of claim 3 wherein the rule that is based on the priority of the two COTs relative to one other is a rule that a highest priority COT of the two COTs is to be considered by the radio node first when the radio node has an opportunity to use either of the two COTs.

7. The method of claim 6 wherein the rule is further that a lowest priority COT of the two COTs is to be considered by the radio node only if the idle period associated to the highest priority COT occurs during the particular transmission.

8. The method of claim 2 wherein the radio node is a wireless communication device, the particular transmission is an uplink transmission, and the one or more rules comprise a rule that if the uplink transmission starts at a beginning of an Fixed Frame Period (FFP) associated to the wireless communication device and ends before an idle period associated to the FFP, the wireless device initiated COT is to be selected or considered first for the particular transmission.

9. The method of claim 2 wherein the radio node is a wireless communication device, the particular transmission is an uplink transmission, and the one or more rules comprise a rule that if the uplink transmission starts at a beginning of a Fixed Frame Period (FFP) associated to a base station associated to the base station initiated COT and ends before an idle period associated to the FFP and the wireless communication device has already determined that the base station initiated COT is initiated, the base station initiated COT is to be selected or considered first for the particular transmission.

10. The method of claim 2 wherein the radio node is a wireless communication device, the particular transmission is a downlink transmission, and the one or more rules comprise a rule that if the downlink transmission starts within a Fixed Frame Period (FFP) associated to a base station associated to the base station initiated COT and ends before an idle period associated to the FFP, the base station initiated COT is to be selected or considered first for the particular transmission.

11. The method of claim 2 wherein the radio node is a wireless communication device, the particular transmission is a second uplink transmission that is subsequent to a first uplink transmission associated to the wireless device initiated COT in a Fixed Frame Period (FFP) and the one or more rules comprise a rule that the second uplink transmission is also associated to the wireless device initiated COT if the second uplink transmission ends before an idle period of the FFP.

12. The method of claim 2 wherein the radio node is a wireless communication device, the particular transmission is a second uplink transmission that is subsequent to a first uplink transmission associated to the base station initiated COT in a Fixed Frame Period (FFP) and the one or more rules comprise a rule that the second uplink transmission is also associated to the base station initiated COT if the second uplink transmission ends before an idle period of the FFP.

13. The method of claim 1 wherein the radio node is a wireless communication device, the particular transmission is an uplink transmission, and selecting the particular COT from among the two COTs comprises selecting the particular COT from among the two COTs autonomously.

14. The method of claim 13 further comprising sending, to a base station associated to the base station initiated COT, information that indicates a priority of the two COTs relative to one another.

15. The method of claim 3 wherein the radio node is a wireless communication device, and the method further comprises choosing the priority of the two COTs relative to one another.

16. The method of claim 15 wherein choosing the priority of the two COTs relative to one another comprises choosing the priority of the two COTs relative to one another based on a rule.

17. The method of claim 15 wherein choosing the priority of the two COTs relative to one another comprises choosing the priority of the two COTs relative to one another based on durations of respective idle periods for the two COTs.

18. The method of claim 1 wherein the radio node is a wireless communication device, and the wireless communication device is configured with two or more Fixed Frame Period (FFP).

19. The method of claim 18 wherein idle periods from one or more FFPs of a base station and idle periods of the two or more FFPs of the wireless communication device are excluded from a downlink preemption resource and/or an uplink cancellation reference resource.

20. (canceled)

21. (canceled)

22. The method of claim 1 wherein the radio node is a wireless communication device, the particular transmission is an uplink transmission, and selecting the particular COT comprises selecting the particular COT from among the two COTs to be used for the uplink transmission based on:
an uplink transmission type of the UL transmission;
one or more time-domain characteristics of the uplink transmission; or
on an importance of the uplink transmission.

23. (canceled)

24. (canceled)

25. The method of claim 1 further comprising transmitting or receiving the particular transmission in the particular COT.

26. The method of claim 1, wherein the radio node is a wireless communication device or a base station.

27. (canceled)

28. A wireless communication device comprising:
one or more transmitters;
one or more receivers; and
processing circuitry associated with the one or more transmitters and the one or more receivers, the processing circuitry configured to cause the wireless communication device to:
determine, for a particular transmission, that the radio node has an opportunity to use either of two channel occupancy times (COTs) consisting of a base station initiated COT and a wireless device initiated COT;
responsive to determining that the radio node has an opportunity to use either of the two COTs, select a particular COT from among the two COTs to be used for the particular transmission;
determine that an idle period associated to the particular COT is a valid idle period in which no transmissions to or from the radio node are to occur.

29. (canceled)

30. (canceled)

31. (canceled)
